(19) United States
(12) Patent Application Publication
(10) Pub. No.: US 2006/0218019 A1
(43) Pub. Date: Sep. 28, 2006

(54) Collaborative risk sharing methods and related products

(76) Inventor: Evan Reis, Menlo Park, CA (US)

Correspondence Address: JENKINS, WILSON, TAYLOR & HUNT, P. A., 3100 TOWER BLVD, SUITE 1200, DURHAM, NC, 27707, US

(21) Appl. No.: 11/088,232

(22) Filed: Mar. 23, 2005

(51) Int. Cl. G06Q 40/00

(52) U.S. Cl. 705/4

(57) ABSTRACT

Collaborative risk sharing methods and related products are disclosed. According to one method, first and second entities can agree to share different risks associated with occurrences of first and second events, respectively. First and second probabilities of an occurrence the first and second events, respectively, can be determined. Further, the method may include a step for assigning first and second values for payment of the first and second entities, respectively, on the occurrence of the first and second events, respectively. The method can also include a step for determining first and second contributions of the first and second entities, respectively, towards the payment on the occurrence of the first and second events, respectively. The first and second entities can have an equal risk/return ratio. The risk/return ratio can be based on the first and second probabilities and the first and second values.

### TECHNICAL FIELD

The subject matter disclosed herein relates to methods for insurance. More particularly, the subject matter disclosed herein relates to collaborative risk sharing methods and related products.

### BACKGROUND ART

Traditionally, insurance is the transfer of risk from the insured to an insurer in return for payment of a premium. The insurer typically sets the premium to an amount equal to the cost of the risk transferred and the insurer's overhead fees and profit. Insurance has been made available for a wide variety of risks such as health problems, property damage, and even gambling losses. Insurance companies are regulated by laws designed to ensure that they are able to pay claims for their policy holders. These laws regulate the amount of assets the insurers must hold, the aggregate size and risk of policies that they can write and the processes by which claims are underwritten and paid.

Problems associated with traditional insurance include cost, settlement, and solvency. The cost for an insurance company to provide insurance has several components. Most fundamental is the cost of the risk transferred. For example, if a customer transfers a 1% annual risk of losing $1,000,000, the cost of the risk transferred is 1%*$1,000,000=$10,000 annually. In this example, insurance would cost the customer $10,000 annually if $10,000 over a one year period described the true risk, the insurer incurred no overhead costs, and did not make a profit. However, the insurer incurs overhead expenses, such as employee pay, a work environment, taxes, equipment expenses, and other fixed and variable expenses. In addition, the insurer must expend effort underwriting each policy, checking that it adheres to regulatory requirements, and processing claims. The insurer must also hold additional assets in reserve to account for the possibility that the true risk will in fact be greater than the estimated risk. These costs are primarily bourne by the customer in the premium. In addition, the insurance premium includes an additional amount representing a profit to the insurance company.

The expenses of the insurance company force insurance premiums to be larger than the actual risk transferred by the customer to the insurer. Typically, these costs alone can be greater than the cost of the risk transferred. In addition, rates are cyclical and often unpredictable. When the general investing climate is good, insurers are able to make higher profits on the investment of assets, and therefore, are able to be more competitive in their pricing. The opposite is true when the markets are down. Following major claims events, rates generally rise, and after long periods without a major claim, rates generally fall. High premium costs relative to true risk and the unpredictability of future costs are two significant disincentives for potential customers to purchase insurance.

As stated above, another problem with traditional insurance is settlement. Settlement of a claim may be difficult or slow to achieve after a damaging event occurs and a claim is submitted, because the amount of loss may be difficult to quantify. For example, in traditional property insurance, damage can include loss to capital, inventory, and loss of business revenues. Other costs that the customer may incur include loss of market share if business cannot be resumed quickly, the loss of prestige, and legal expenses. Many of these losses are not traditionally included in insurance coverage because they are difficult to quantify. A claims adjuster must compare the estimated damage and loss to the policy limits and recommend a settlement amount. This process may take weeks or months. Once the claim is adjusted, the policy holder may dispute the settlement amount and request a greater settlement. For example, claims from the 1994 Northridge and the 1993 Guam earthquakes were outstanding six to eight years after the event due to disputes. Furthermore, legal costs can range from thousands to millions of dollars, depending on the amount of the claim. The time and cost associated with claims settlement can be a significant challenge to the ability of the policy holder to recover losses.

The third problem with traditional insurance mentioned above is solvency. When major natural or man-made disasters occur, large property/casualty claims can exceed the ability of insurers to pay. For example, following the 1992 Hurricane Andrew, nine insurers became insolvent. When an insurer becomes insolvent, it may not be able to pay its policyholders' claims. In these instances, customers suffering damage from the event may not receive payment even though they have dutifully paid their premiums.

One alternative to the above-described traditional form of insurance is self insurance where an individual or business entity retains the risk entirely itself. Self insurance can be beneficial because insurance company overhead and settlement costs are eliminated. However, for catastrophic events, the self-insured may not have sufficient resources to cover the entire loss. Corporations that have assets or revenue concentrated in a few geographical area are often least able to self insure because a single large disaster can devastate the entire corporation. Similar risks are faced by universities and municipalities.

Alternative risk transfer products (ARTs) are other forms of insurance that attempt to address the shortcomings of traditional insurance. One form of ART is known as a captive. A captive is an insurance company formed by companies having similar business operations. Members of the captive pay premiums similar to traditional insurance and receive payments in the event of an insured loss. Typically, captives cover a specific type of loss, such as workers' compensation, liability, or health care. In addition, the captive may return dividends on invested assets. Using a captive may also reduce administration fees. However, the same problems inherent with traditional insurance can exist with captives. Premiums are still typically higher than the true risk transferred. Settlement disputes may not be eliminated and captives may fail when unanticipated losses exceed their capacity to pay.

Another form of ART is an insurance pool. An insurance pool is formed when entities having similar risks form a group to buy traditional insurance at reduced premiums. Unions, professional organizations, cities, and employer health plans are examples of types of entities that traditionally take advantage of insurance pooling. Insurance pooling is not typically practical for catastrophic property/casualty loss because size of the group may be too small to obtain economies of scale. Likewise, insurance pooling does not reduce settlement costs or the risk that the insurer will become insolvent after a major regional event.

Risk retention groups are another form of ART. These groups are owner-controlled entities that were authorized in the United States in 1986. Risk retention groups allow members who engage in similar or related business to write liability insurance for the exposures of group members, excluding first party coverages, such as property, workers compensation, and personal lines. Advantages of risk retention groups include the ability to domicile in a single state, reduced fees and licensing requirements, greater control over claims settlement, and more stable rate setting. However, risk retention groups are disadvantageous because the types of risks that can be insured are limited and risk retention groups can only be composed of entities with similar businesses. Further, claims may still exceed the ability of the risk retention group to pay.

Catastrophe bonds are another form of ART. These types of bonds are typically made available by an insurance or reinsurance company. Catastrophe Bonds are not traditional insurance products; rather they are investments and are regulated by the United States Securities Exchange Commission (SEC). Investors may purchase these bonds and be paid interest until the bond matures. When the bond matures, principal is returned. The bond contract stipulates that the investor may temporarily or permanently forfeit some or all of its investment if a stipulated damaging event affects the seller before the maturity date. Some catastrophe bonds are “parametrically triggered”, meaning that the amount the investor forfeits is based on the size and location of the disaster only, not on a claims adjustment. This allows claims to be paid almost immediately after the size of the event is determined. Catastrophe bonds can eliminate the risk of insolvency because the proceeds are held in trust until they are either returned to the investor or paid to the seller. The primary disadvantages of catastrophe bonds are cost and regulatory hurdles. Scientists are not able to estimate the frequency of catastrophic events with as much certainty as the market can estimate the likelihood of companies defaulting on their credit. This uncertainty may cause the cost of catastrophe bonds to be two or three times the actual risk transferred.

As identified above, some of the problems associated with current insurance and ART forms include cost, settlement, and solvency. Accordingly, in light of these problems associated with currently available forms of insurance, there exists a need for improved collaborative insurance products and related methods for addressing these problems.

### SUMMARY

According to one aspect, the subject matter described herein comprises methods and related products for collaborative risk sharing. A method according to one embodiment can include selecting first and second entities for agreeing to share different risks associated with occurrences of first and second events, respectively. The method may also include determining first and second probabilities of an occurrence the first and second events, respectively. Further, the method may include assigning first and second values for payment to the first and second entities, respectively, on the occurrence of the first and second events, respectively. The method can also include determining first and second contributions of the first and second entities, respectively, towards the payment on the occurrence of the first and second events, respectively. The first and second entities can have an equal risk/return ratio. The risk/return ratio can be based on the first and second probabilities and the first and second values.

According to another aspect, a method can include selecting a plurality of entities for agreeing to share different risks associated with occurrences of a plurality of events. Each event can have an independent risk of occurring. The method can also include determining probabilities of an occurrence of each event. Further, the method can include assigning values for payment to each entity on the occurrences of the events. Each entity can contribute towards the payment of the assigned values.

### BRIEF DESCRIPTION OF THE DRAWINGS

Preferred embodiments of the subject matter described herein will now be explained with reference to the accompanying drawing of which:

FIG. 1 is a flow chart of a process for collaborative risk sharing according to one embodiment of the subject matter described herein; and

FIG. 2 is a flow chart of a process for paying an entity under the collaborative risk sharing agreement of FIG. 1 according to one embodiment of the subject matter described herein.

### DETAILED DESCRIPTION

Collaborative risk sharing products and methods according to the subject matter provided herein may be utilized by a group of persons and/or business entities desiring to share risks among themselves. Individuals or business entities may enter into an agreement to provide payments to one another in the event that one of the entities suffers a loss due to a specified event, such as a hurricane or earthquake. The method and products described herein can provide a means for calculating a risk/return ratio for each entity. Further, the methods and products described herein can provide a means for determining the payment or receipt amount for each entity.

The use of collaborative insurance products and methods according to the subject matter provided herein can provide benefits over traditional insurance forms in terms of cost, settlement, and solvency. Regarding cost, the collaborative risk sharing products and methods according to the subject matter described herein can eliminate the need to assign risks to a third party insurer because the risks are shared among the entities. The entities contribute a payment to the entity associated with a stipulated event only after the occurrence of the event. Thus, premiums are eliminated. By eliminating premiums associated with traditional insurance, the overhead costs of traditional insurance may be eliminated.

Regarding settlement, the collaborative insurance products and methods according to the subject matter described herein can provide efficient settlement of payments due on the occurrence of an event stipulated in the agreement. In a preferred collaborative risk sharing implementation, entities are required to provide assurance of the liquidity of payment funds on the occurrence of an event. Entities may hold the funds in escrow or provide a letter of credit. Because entities are required to maintain funds readily available, payment should always be readily available on the occurrence of a triggering event. Because payments can be quantified according to pre-agreed upon triggers, settlement disputes may be less likely and settlement times can be greatly reduced.

Further, in a preferred collaborative risk sharing implementation, each event must have an independent risk of occurring. Independent risks means that a single event associated is only expected to affect one entity within the agreement. If the risk is independent, it is a greatly reduced chance that one event will cause losses for more than one entity. With traditional insurance it is common for an insurer to insure multiple properties in the same geographical area, thus increasing the possibility of a single event causing losses for more than one entity.

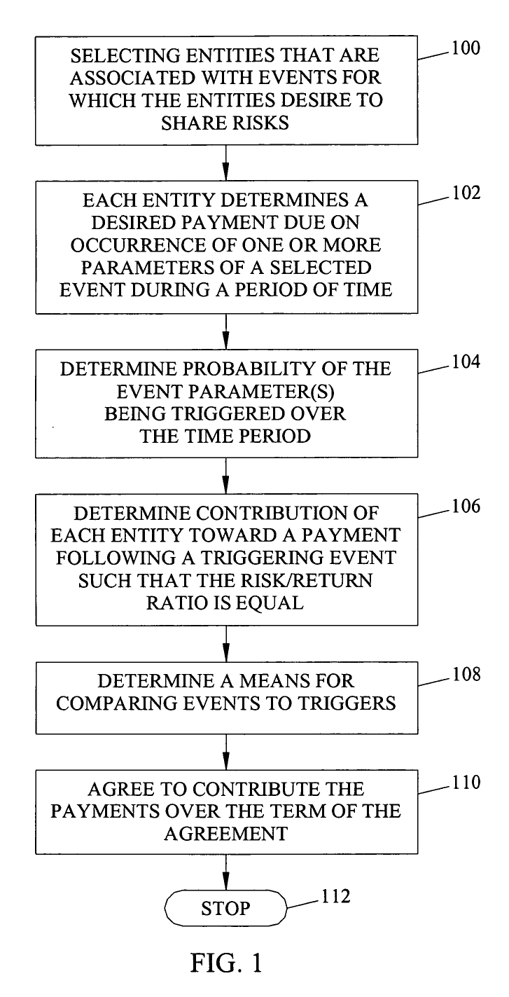

FIG. 1 is a flow chart illustrating a process for collaborative risk sharing among a plurality of entities according to one embodiment of the subject matter described herein. Referring to FIG. 1, the process begins at step 100 when entities are selected that are associated with a plurality of events for which the entities desire to share risks. Each entity may be exposed to a risk of loss on the occurrence of its associated event. The entities may be any type of entity, such as a person, corporation, partnership, or any suitable type of business organization. Each participating entity can identify at least one event for which it desires to share risk with the other entities.

The events for each entity may be independent of one another such that it is unlikely the occurrence of one event will result in losses for more than one entity. When the risks are independent, it provides assurance to the entities that two payments will not likely result from a single event. For example, it may not be desirable for two entities located in Miami to enter into an agreement through which both are covered for hurricane damage. This is because a hurricane event occurring in Miami may result in payments being made to both entities. However, it may be practical for two casinos in the same city to agree to share the risk of a patron hitting a large jackpot because the two gambling risks are independent.

Preferably, the probabilities of the events occurring are quantifiable either absolutely or relative to another event. Quantifiable events are events for which at least some empirical or scientific data is available from which to form a statistical predictive model. Quantifiable events may be utilized for comparing the likelihood of events occurring with respect to one another. Examples of quantifiable events include earthquakes, hurricanes, windstorms, floods, hailstorms, power outages, cold or hot weather, fire, risks of gambling loss, lottery loss, event nonperformance, business default, market fluctuations, economic downturn, and other business events. In contrast, unquantifiable events include events for which there is a minimal or no empirical or scientific data from which to form a statistical predictive model.

Although an event may not be absolutely quantifiable, the likelihood of the event occurring may be comparable to another event. As described further herein, such events are useful because they may be quantifiably compared. Exemplary events that are quantifiable with respect to one another are terrorist acts. In some cases, it may be possible to compare the likelihood of two different terrorist acts occurring. For example, entities at risk to a terrorist act which is unquantifiable may enter into an agreement if the risk of the terrorist act for one of the entities is twice the risk for the other entity.

Next, at step 102, each entity may determine a desired payment due on the occurrence of one or more parameters of a selected event. The payment may be utilized by the entity to compensate for any losses resulting from the occurrence of the event. For example, the occurrence of the event may expose the entity to a risk of loss of capital, contents, casualties, business interruption, market share, prestige, or any other actual or unquantifiable loss by the entity. Because each entity quantifies its own loss in advance of the event occurring, the settlement costs of traditional insurance are avoided.

An entity may also specify parameters related to its selected event that trigger a payment to the entity when the specified parameters are met. The entity may specify desired payment terms on the occurrence of an event meeting the specified parameters. In particular, the amount that the entity receives can be based on a function of parameters such as the size and/or location of the event. If the parameter or parameters are met, a payment is triggered in the amount specified by the entity.

For example, an entity may determine that magnitude 6.5 and 7.0 earthquakes occurring within 10 miles of its headquarters will result in a risk of losses totaling $16 million and $20 million, respectively. The losses may be estimated utilizing engineers, consultants, historical data, insurance estimates or other means for estimating damages. In this example, the entity may be able to absorb $10 million in losses through other means and desires to receive payment of $6 million in a magnitude 6.5 or greater earthquake within 10 miles of its headquarters and $10 million in a magnitude 7.0 or greater earthquake within the same area.

Payment terms may also be set based on a parametric scale for an event. For example, an entity may receive 50% of a predetermined payment amount if an earthquake measures 6.5 or greater and is within 10 miles of the entity's headquarters, and the entity can receive 100% of the predetermined payment amount if the earthquake measures 7.0 or greater. The receipt of these payments can be made regardless of the actual losses suffered.

Table 1 below shows an example of parametric triggers for entities A and B.

TABLE 1
Exemplary Parametric Triggers

| | | | Location of | |
|---|---|---|---|---|
| | | | Event with | |
| | | | Respect to the | |
| Entity | Risk | Size of Event | Headquarters | Payment |
| A | Earthquake | >6.5 Mag. | <10 miles | $6,000,000 |
| | | >7.0 Mag. | <10 miles | $10,000,000 |
| B | Hurricane | >Category 3 | <20 miles | $8,000,000 |
| | | >Category 4 | <20 miles | $12,000,000 |

Once each entity selects an event and an amount to be paid to the entity upon the occurrence of the event, at step 104, the probability of the event parameter or parameters being triggered over a period of time can be determined. The time period can be the amount of time that the entities desire to share risks with one another. The probability of these events occurring over the time period may be scientifically and empirically estimated. As described further herein, an independent third party may determine the probability of the events occurring over the time period. The independent third party may also determine the probability of the risks occurring with respect to one another. The use of an independent third party for determining the probabilities will increase confidence that the risk and returns will be fairly assessed among the entities.

At step 106, the contribution of each entity toward a payment following a triggering event is determined. Each entity has a risk of having to contribute a settlement to an entity suffering a loss. Further, each entity may receive a return in a settlement if it suffers a loss. Preferably, no entity should receive a higher potential return relative to its potential risks than any other. Therefore, the settlement contribution of each entity must be such that each entity has an equal risk/return ratio, preferably 1.0. The risk/return ratio refers to the ratio of: 1. the probability that an entity will be required to pay for a loss times the amount of the loss and 2. the probability that the entity will be paid for a loss times the amount of payment.

In order to achieve an equal risk/return ratio for each entity, the amounts of potential payment and potential return must be balanced with the likelihood of making and receiving a payment. Return for an entity can be determined by multiplying a set payment for an event and the probability of the event parameter occurring. For example, the event parameter for entity A is the occurrence of an earthquake having a probability of 1%, and the event parameter for entity B is the occurrence of a hurricane having a probability of 2.25%. Entity A selects to receive $6,000,000 on the occurrence of the earthquake. Entity B selects to receive $8,000,000 on the occurrence of the hurricane. Since entity A has a 1% chance of receiving a $6,000,000 payment, its expected return is 1%*$6,000,000=$60,000. Further, since entity B has a 2.25% chance of receiving an $8,000,000 payment, its expected return is $180,000. Therefore, entity B can expect to receive three times the return of entity A. Since entity B stands to receive three times the return of entity A, entity B should have three times the risk of payment as entity B. If both agree to share the risks equally, entity A commits to paying ¼ of any payment due to entity B. Likewise, entity B commits to paying ¾ of any payment due to entity A. Entity A has a 1% risk of paying itself ¼ of $6,000,000 or $1,500,000 and a 2.25% risk of paying entity B ¼ of $8,000,000 or $2,000,000. Its total risk is then 1%*$1,500,000+2.25%*$2,000,000=$60,000. Likewise, entity B has a 2.25% risk of paying itself ¾ of $8,000,000 or $6,000,000 and a 1% risk of paying entity A ¾ of $6,000,000 or $4,500,000. Entity A's total risk is then 2.25%*$6,000,000+1%*$4,500,000=$180,000. As shown, entity A's risk/return ratio is $60,000/$60,000, a 1.0 risk/return ratio. Entity B's risk/return ratio is $1,800,000/$1,800,000, a 1.0 risk/return ratio.

Requiring that all of the entities have equal risk/return ratios provides a disincentive for entities desiring to speculate on their returns. For example, since the amount that an entity is required to pay in response to a loss by another entity increases with the return requested by the first entity, each entity has an incentive to more accurately characterize its potential losses.

According to one embodiment, the risk/return ratio is equal for each entity regardless of the number of entities, the actual losses suffered by each entity, or the probability of an event occurring. The relative contribution each entity is required to make if an event occurs is adjusted as described above so that the risk/return ratio for each entity equals 1.0. The following mathematical equation may be utilized for determining the contribution of each entity toward a payment following a triggering event (wherein, Cᵢ is the contribution by entity i, L is the loss suffered in an event, Pᵢ is the probability of an event occurring to entity i, Lᵢ is the amount of loss suffered in event occurring to entity i, and n is the number of entities entering into the agreement):

$${C}_{i} = L * \frac{{P}_{i} * {L}_{i}}{{\sum }_{i = 1}^{n} {P}_{i}^{*} {L}_{i}}$$

Alternatively, loss L can be the value that the entity selects to receive on occurrence of its associated event. The value selected may be independent of the actual losses of the entity.

The above mathematical equation may be extrapolated so that different payments can be made for different triggers. For example, as with Table 1 above, each entity may be paid according to the probability of occurrence of a range of different triggering events. Still, the aggregate risk/return ratio for each entity should equal 1.0. The following mathematical equation may be utilized for determining the contribution of each entity toward a payment for a range of different triggering event (wherein, Cᵢ is the contribution by entity i, L is the loss suffered in an event, Pᵢⱼ is the probability of event j occurring to entity i, Lᵢⱼ is the amount of loss suffered in event j occurring to entity i, r is the number of triggering events for each entity, and n is the number of entities entering into the agreement):

$${C}_{i} = L * \frac{{\sum }_{j = 1}^{r} {P}_{ij} * {L}_{ij}}{{\sum }_{i = 1}^{n} {\sum }_{j = 1}^{r} {P}_{ij} * {L}_{ij}}$$

Alternatively, loss L can be the value that the entity selects to receive on occurrence of its associated event. The value selected may be independent of the actual losses of the entity.

Once each entity agrees on a contribution amount based on a risk return ratio, at step 108, the entities can determine the means by which events are compared to event triggers. The means may depend on the type of event and be an independent agency that makes the determination. For example, for natural disasters, such as hurricanes and earthquakes, government agencies such as the National Oceanic and Atmospheric Agency (NOAA) or the United States Geological Survey (USGS) can make a statement of the parameters of an event by which triggers can be compared. For example, the USGS can determine the magnitude and epicentral location of an earthquake and NOM can plot a windspeed path for a hurricane. According to one embodiment, the agreement can stipulate that the agency's final determination of the event trigger a specified period following the event will be accepted by all the parties to the agreement.

At step 110, each entity agrees to contribute the stipulated payments over the term of the agreement. The agreement stipulates that each entity will make a payment if an event trigger is met. According to one embodiment, the promise is guaranteed by an irrevocable letter of credit or funds held in escrow sufficient to pay any possible claim. In the above-described example, if the maximum loss for entity B i is $12,000,000 and entity A's contribution is ¼ of that, or $3,000,000, then Entity A would have to obtain a letter of credit or an escrow account in that amount. The letter of credit or escrow terms may stipulate that the money is to be released to the suffering entity once the occurrence of the triggering event has been verified. The terms can also stipulate the liquidity of the investments into an escrow account. The implementation of this embodiment can assure that the settlement of payments for a triggering event will be made available quickly following the event.

At step 112, the process ends and results in a collaborative risk sharing agreement among the entities. The agreement may be enforced for the time period specified in the agreement. During the term of the agreement, the entities may receive payments when an event trigger occurs. As stated above, an agreed upon independent agency may make a statement of the parameters of the event by which triggers are compared. The entities can make payments to the entity associated with the event as set forth in the agreement.

According to one embodiment, an agent can provide a product or service for grouping together entities that are interested in sharing risks in accordance with the collaborative insurance products and related methods described herein. The agent can advertise for grouping interested entities and facilitate determining a desired payment (step 102), determining the probability of the event parameters being triggered occurring over an agreement term (step 104), determining contribution of each entity toward a payment (step 106), determining a means for comparing events to triggers (step 108), and negotiating the agreement between the entities (step 110).

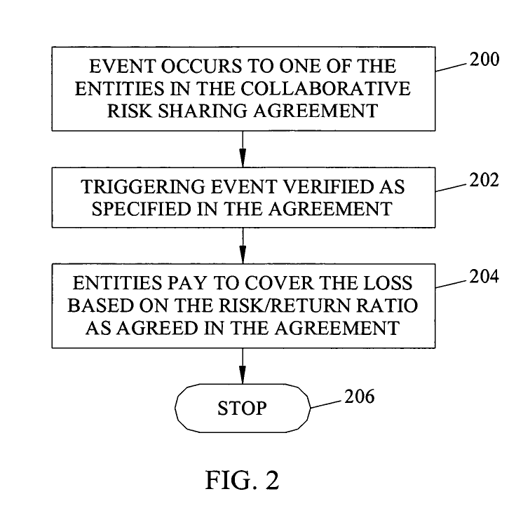

FIG. 2 is a flow chart illustrating a process for paying an entity under the collaborative risk sharing agreement of FIG. 1 according to one embodiment of the subject matter described herein. Referring to FIG. 2, the process begins at step 200 when an event occurs corresponding to a stipulated event in the collaborative risk sharing agreement. Next, at step 202, the event is verified to be a triggering event as specified in the agreement. The entities then pay to cover the loss based on the risk/return ratio as agreed upon in the agreement (step 204). The process ends at step 206. The process can repeat if another event occurs over the term of the agreement.

Thus, collaborative risk sharing products and methods as described herein are advantageous over traditional insurance in terms of cost, settlement, and solvency. For example, regarding cost, the collaborative insurance products and methods described herein can eliminate overhead costs associated with using a third party insurer. Settlement costs are also reduced because the parties agree upon the amount that each party will pay and event triggers in advance of the occurrence of an event. Risk of insolvency is reduced by requiring each party guarantee or set aside a sufficient amount of money to cover each party's obligation under the collaborative risk sharing agreement.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for collaborative risk sharing, the method comprising:
(a) selecting first and second entities for agreeing to share different risks associated with occurrences of first and second events, respectively;
(b) determining first and second probabilities of an occurrence of the first and second events, respectively;
(c) assigning first and second values for payment to the first and second entities, respectively, on the occurrence of the first and second events, respectively; and
(d) determining first and second contributions of the first and second entities, respectively, towards the payment on the occurrence of the first and second events, respectively, such that the first and second entities have an equal risk/return ratio, wherein the risk/return ratio is based on the first and second probabilities and the first and second values.

2. The method of claim 1 wherein selecting the first and second entities comprises selecting the first and second entities for agreeing to share independent risks associated with occurrences of the first and second events.

3. The method of claim 1 wherein selecting the first and second entities comprises selecting the first and second entities for agreeing to share quantifiable risks associated with occurrences of the first and second events.

4. The method of claim 1 wherein selecting the first and second entities comprises selecting the first and second entities for agreeing to share quantifiable risks associated with occurrences of the first and second events, respectively, wherein the probability of the first event occurring is quantifiable with respect to the probability of the second event occurring.

5. The method of claim 1 comprising determining parameters of the first and second events for triggering payments of the first and second values, respectively.

6. The method of claim 5 wherein the parameters include a parameter selected from the group consisting of size, geographic location, hurricane category, earthquake magnitude, and any combination thereof.

7. The method of claim 1 comprising determining occurrences of the first and second events.

8. The method of claim 7 comprising paying the first and second entities the first and second values, respectively, in response to determining the occurrences of the first and second events, respectively.

9. The method of claim 7 wherein determining occurrences of the first and second events comprises utilizing an independent third party for determining the occurrences of the first and second events.

10. The method of claim 1 wherein determining the first and second contributions comprises using the following equation:
$${C}_{i} = L * \frac{{P}_{i} * {L}_{i}}{{\sum }_{i = 1}^{n} {P}_{i}^{*} {L}_{i}}$$
wherein, Cᵢ is the contribution by entity i, L is the payment made on the occurrence of an event, Pᵢ is the probability of an event occurring to entity i, Lᵢ is the payment made to entity i on the occurrence of an event to entity i, and n is the number of entities.

11. The method of claim 1 wherein determining the first and second contributions comprises using the following equation:
$${C}_{i} = L * \frac{{\sum }_{j = 1}^{r} {P}_{ij} * {L}_{ij}}{{\sum }_{i = 1}^{n} {\sum }_{j = 1}^{r} {P}_{ij} * {L}_{ij}}$$
wherein, Cᵢ is the contribution by entity i, L is the payment made on the occurrence of an event, Pᵢⱼ is the probability of event j occurring to entity i, Lᵢⱼ is the payment made to entity i on the occurrence of event j, r is the number of events associated with each entity, and n is the number of entities.

12. The method of claim 1 wherein determining the first and second contributions includes providing that the risk/return ratio is 1.

13. A method for collaborative risk sharing, the method comprising:
(a) selecting a plurality of entities for agreeing to share different risks associated with occurrences of a plurality of events, wherein each event has an independent risk of occurring;
(b) determining probabilities of an occurrence of each event; and
(c) assigning values for payment to each entity on the occurrences of the events, wherein each entity contributes towards the payment of the assigned values.

14. The method of claim 13 wherein determining probabilities includes determining probabilities that are quantifiable.

15. The method of claim 13 wherein determining probabilities includes determining probabilities that are quantifiable with respect to each other.

16. The method of claim 13 comprising determining parameters of the events for triggering payments of the assigned values.

17. The method of claim 16 wherein determining the parameters comprises selecting the parameters are selected from the group consisting of size, geographic location, hurricane category, earthquake magnitude, and any combination thereof.

18. The method of claim 13 comprising determining occurrences of the events.

19. The method of claim 18 comprising paying the entities the values in response to determining the occurrences of the events.

20. The method of claim 19 wherein determining probabilities of the occurrence of each event comprises utilizing an independent third party for determining the occurrences of the events.

21. The method of claim 13 wherein assigning values for payment comprises using the following equation:
$${C}_{i} = L * \frac{{P}_{i} * {L}_{i}}{{\sum }_{i = 1}^{n} {P}_{i}^{*} {L}_{i}}$$
wherein, Cᵢ is the contribution by entity i, L is the payment made on the occurrence of an event, Pᵢ is the probability of an event occurring to entity i, Lᵢ is the payment made to entity i on the occurrence of an event to entity i, and n is the number of entities.

22. The method of claim 13 wherein assigning values for payment comprises using the following equation:
$${C}_{i} = L * \frac{{\sum }_{j = 1}^{r} {P}_{ij} * {L}_{ij}}{{\sum }_{i = 1}^{n} {\sum }_{j = 1}^{r} {P}_{ij} * {L}_{ij}}$$
wherein, Cᵢ is the contribution by entity i, L is the payment made on the occurrence of an event, Pᵢⱼ is the probability of event j occurring to entity i, Lᵢⱼ is the payment made to entity i on the occurrence of event j, r is the number of events associated with each entity, and n is the number of entities.

23. The method of claim 13 wherein assigning values for payments includes that the entities have an equal risk/return ratio based on a probability of making a contribution on the occurrence of the events and on the probability of receiving payment on the occurrence of the events.

24. The method of claim 23 wherein assigning values for payments includes that the risk/return ratio is 1.
